(19) United States
(12) Patent Application Publication
(10) Pub. No.: US 2004/0181300 A1
(43) Pub. Date: Sep. 16, 2004

(54) Methods, apparatus and computer program products for adaptively controlling a system by combining recursive system identification with generalized predictive control

(76) Inventors: Robert L. Clark JR., Chapel Hill, NC (US); Suk-Min Moon, Durham, NC (US)

Correspondence Address: MYERS BIGEL SIBLEY & SAJOVEC, PO BOX 37428, RALEIGH, NC, 27627, US

(21) Appl. No.: 10/386,355

(22) Filed: Mar. 11, 2003

(51) Int. Cl. G05B 13/02; G05B 21/02

(52) U.S. Cl. 700/73; 700/30; 700/31

(57) ABSTRACT

Methods, apparatus and computer program products combine recursive least squares system identification operations and generalized predictive control operations to yield recursive generalized predictive control (RGPC) operations that can simultaneously achieve robust performance and robust stability characteristics. These RGPC operations can be applied in real-time without prior system (plant) information for control design because the operations for system identification are performed continuously. Moreover, the RGPC operations can be applied in the presence of changing operating environments because the control design is updated adaptively.

### GOVERNMENT SUPPORT

The present invention was made, in part, with the support of grant number F49620-98-1-0383 from the AFOSR. The United States government has certain rights to this invention.

### FIELD OF THE INVENTION

The present invention relates to adaptive control of systems and, more particularly, to real-time adaptive control systems that perform recursive system identification operations.

### BACKGROUND OF THE INVENTION

Control systems are dynamic systems that behave in a prescribed way as a function of time, typically without human intervention. As illustrated by FIG. 1, the components of a closed-loop control system 10 are: (i) the plant 12, which is the system to be controlled; (ii) one or more sensors 14, which provide information about the plant; and (iii) the controller 16, the “heart” of the control system, which typically compares measured values to their desired values and adjusts the input variables to the plant. A simple example of a conventional control system is a self-regulating home heating system, which can be configured to maintain a fairly constant temperature inside the home even though the outside temperature may vary considerably. The system operates without human intervention, except that the desired temperature is set. In this control system, the plant is the home and the heating equipment. The sensor generally consists of a temperature transducer inside a home thermostat. The controller is usually combined with the temperature transducer in the thermostat, which switches the heating equipment on and off as necessary to maintain the desired temperature.

FIG. 2 illustrates a slightly more complex closed-loop control system 10′ that can be used to solve a “tracking” problem, which means automatically finding an appropriate input variable so that a controlled variable tracks a selected reference variable. In FIG. 2, the value u(t) represents a controllable input variable that influences the plant 12, and the value vₚ(t) represents a disturbance variable that influences the plant 12, but which cannot be manipulated or controlled. The value y(t) represents an observed variable(s), which is provided to the controller 16. The observed variable y(t), which is measured by means of sensors 14, provides information about the state of the plant 12. The observed variable y(t) may be contaminated by observation noise vₘ(t). The value z(t) represents the variable to be controlled and the value r(t) represents the prescribed value of the controlled variable z(t). The value z(t) may also be referred to as a performance variable.

More sophisticated closed-loop control systems may use predictive control concepts, which represent an extension of one-step-ahead predictors. Predictive control is based on the following steps: output prediction, control calculation and feedback implementation. One exemplary predictive control method, known as generalized predictive control (GPC), starts with an AutoRegressive moving average model with eXogenous input (ARX) that is absent a direct transmission term and builds a multi-step ahead predictor. A predictive control law is then computed using a Toeplitz matrix formed from the step response time history of the system (i.e., plant) in conjunction with a cost function with weighted input and weighted output.

There are three design parameters associated with GPC. These three design parameters include control weight, prediction horizon and control horizon. Because a proper combination of these there parameters may be required in order to guarantee stability of the predictive control law, different variants of the method have been proposed which yield stabilizing control. One such variant includes continuous generalized predictive control (CGPC), which guarantees closed-loop stability in only limited cases. Another variant, which has been applied to discrete-time systems and a continuous-time extension, includes stable continuous generalized predictive control (SCGPC). A further variant, which is similar to GPC because it also uses a receding horizon controller, is deadbeat predictive control (DPC). These predictive control concepts are more fully described in an article by Suk-Min Moon et al., entitled “The Theory and Experiments of Recursive Generalized Predictive Control,” Proceedings of the 2002 ASME International Mechanical Engineering Congress and Exposition, Nov. 17-22, (2002), the disclosure of which is hereby incorporated herein by reference.

Notwithstanding these advanced closed-loop control methods that utilize predictive control operations, there continues to be a need for further control methods that can have more robust performance and stability characteristics, which can be optimized for a given plant and system.

### SUMMARY OF THE INVENTION

Embodiments of the present invention combine recursive least squares system identification operations and generalized predictive control operations to yield recursive generalized predictive control (RGPC) operations that can simultaneously achieve robust performance and robust stability characteristics. These RGPC operations can be applied in real-time without prior system (plant) information for control design because the operations for system identification are performed continuously. Moreover, the RGPC operations can be applied in the presence of changing operating environments because the control design is updated adaptively.

Methods of adaptively controlling systems according to first embodiments of the present invention include recursively identifying a model of the system at a first rate from data that is input to the system and sampled at the first (or higher) rate and data that is output from the system and sampled at the first (or higher) rate. These methods also include determining a time-varying generalized predictive controller that is updated at a second rate less than the first rate, from the recursively identified model. Updated data inputs to the system are also generated by sampling the time-varying generalized predictive controller at the first (or higher) rate. According to preferred aspects of these first embodiments, the operations to determine a time-varying generalized predictive controller include using a first time-varying input weighting factor (λ₁(t)) and then testing a stability of the system to identify it as stable or unstable. If necessary or desireable to achieve or improve stability, the time-varying generalized predictive controller is updated using a second time-varying input weighting factor that is greater than (or less than) the first time-varying input weighting factor (i.e., (λ₂(t)=λ₁(t)±τ). The operations that use time-varying input weighting factors and dual sampling rates may be performed so that aggressive higher order controllers can be achieved.

The operations to recursively identify a model of the system may also include evaluating linear combinations of prior data to the system and measured prior outputs from the system to yield system input parameters and system output parameters, which may be ARX parameters. These system input parameters and system output parameters may be sampled at the second rate during the operations to determine the time-varying generalized predictive controller. The operations to determine a time-varying generalized predictive controller may also include evaluating a cost function that is a function of a prediction horizon, a control horizon and the time-varying input weighting factor λ(t).

Methods of adaptively controlling a system may also include operations to recursively identify a model of the system by evaluating linear combinations of control inputs to the system and measured sensor outputs from the system that are sampled at a first rate. Further operations include determining a time-varying generalized predictive controller that is a function of a first time-varying input weighting factor. This controller is preferably updated at a second rate that is less than one-half the first rate. Updated control inputs may be generated to the system by sampling the time-varying generalized predictive controller at the higher first rate.

Additional embodiments of the present invention include computer program products that are configured to perform adaptive control operations for a system comprising plant, sensor and computer interface devices. The computer program products include a computer-readable storage medium having computer-readable code embodied in the medium. The computer-readable code includes code that recursively identifies a model of a system at a first rate from data that is input to the system and sampled at the first (or higher) rate and data that is output from the system and sampled at the first (or higher) rate. Additional code is also provided that determines a time-varying generalized predictive controller, which is updated at a second rate that is less than the first rate, from the recursively identified model. This determination of the time-varying generalized predictive controller may also include using a first time-varying input weighting factor. Still further code is provided that generates an updated data input to the system by sampling the time-varying generalized predictive controller at the first (or higher) rate. Here, the recursive system identification operations can be performed at a rate which is equivalent to data sampling/acquisition rate because it may update system ARX parameters using matrix summation and multiplication operations instead of more time consuming matrix inversion operations. Moreover, by reducing the rate of change of the system ARX parameters, a slower sampling rate than the data acquisition rate can be used for the generalized predictive controller design because matrix inversion operations typically must be performed twice during the control design.

Additional computer program products may also include computer-readable program code that recursively identifies a model of the system by evaluating linear combinations of control inputs to a system and measured sensor outputs from the system that are sampled at a first rate. From this recursively identified model, the code further determines a time-varying generalized predictive controller that is a function of a first time-varying input weighting factor and is updated at a second rate that is less than one-half the first rate, from the recursively identified model. This code may also generate updated control inputs to the system by sampling the time-varying generalized predictive controller at the first rate. These control inputs may be provided to a computer interface unit that translates these control inputs and signals into those usable by the system plant.

Still further embodiments of the present invention include recursive generalized predictive control systems with means therein for recursively identifying a model of a system at a first rate from data that is input to the system and sampled at the first (or higher) rate and data that is output from the system and sampled at the first (or higher) rate. These control systems also include means for determining a time-varying generalized predictive controller that is updated at a second rate less than the first rate and means for generating an updated data input to the system by sampling the time-varying generalized predictive controller at the first rate. To enhance stability characteristics, the determining means includes means for determining a time-varying generalized predictive controller using a first time-varying input weighting factor (λ₁(t)) and means for testing a stability of the system to identify it as stable or unstable. In response to this stability testing, the means for updating the time-varying generalized predictive controller may include improving stability by using a second time-varying input weighting factor (λ₂(t)) that has been adjusted by a value |τ|.

### BRIEF DESCRIPTION OF THE DRAWINGS

FIG. 1 is a block diagram of a conventional closed-loop control system according to the prior art.

FIG. 2 is a block diagram of a conventional closed-loop control system according to the prior art.

FIG. 3A is a block diagram of a closed-loop control system according to an embodiment of the present invention.

FIG. 3B is a block diagram of a computer controlled closed-loop control system according to another embodiment of the present invention.

FIG. 4 is a flow-diagram of operations of adaptively controlling systems according to embodiments of the present invention.

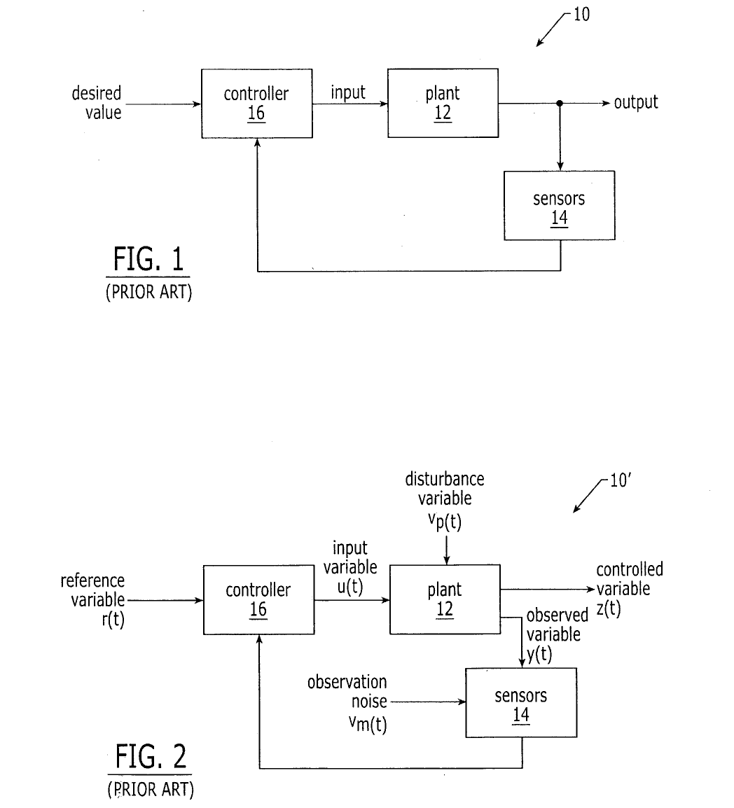

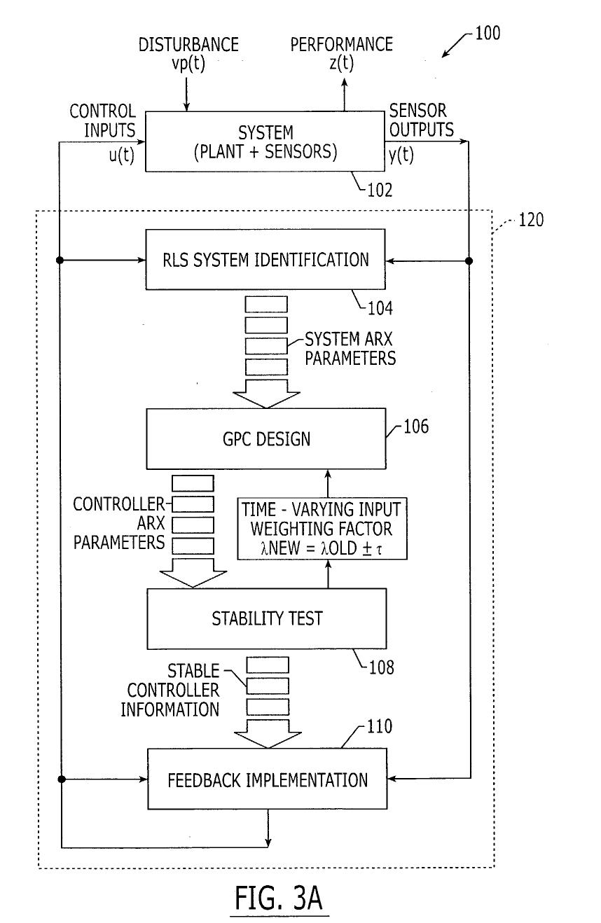

### DETAILED DESCIPTION OF PREFERRED EMBODIMENTS

The present invention now will be described more fully hereinafter with reference to the accompanying drawings, in which embodiments of the invention are shown. This invention may, however, be embodied in many different forms and applied to other articles and should not be construed as limited to the embodiments set forth herein; rather, these embodiments are provided so that this disclosure will be thorough and complete, and will fully convey the scope of the invention to those skilled in the art. The operations of the present invention, as described more fully hereinbelow and in the accompanying figures, may be performed by an entirely hardware embodiment or, by an embodiment combining both software and hardware aspects and possibly some degree of user input. Furthermore, aspects of the present invention may take the form of a computer program product on a computer-readable storage medium having computer-readable program code embodied in the medium. Any suitable computer-readable medium may be utilized including hard disks, CD-ROMs or other optical or magnetic storage devices. Like numbers refer to like elements throughout.

Various aspects of the present invention are illustrated in detail in the following figures, including flowchart illustrations. It will be understood that each of a plurality of blocks of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the operations specified in the flowchart block or blocks. These computer program instructions may also be stored in a computer-readable memory that can direct a processor or other programmable data processing apparatus to function in a particular manner, such that the instructions stored in the computer-readable memory produce an article of manufacture including instruction means which implement the operations specified in the flowchart block or blocks.

Accordingly, blocks of the flowchart illustrations support combinations of means for performing the specified operations, combinations of steps for performing the specified operations and program instruction means for performing the specified operations. It will also be understood that each of a plurality of blocks of the flowchart illustrations, and combinations of blocks in the flowchart illustrations, can be implemented by special purpose hardware-based computer systems that perform the specified operations or steps, or by combinations of special purpose hardware and computer instructions.

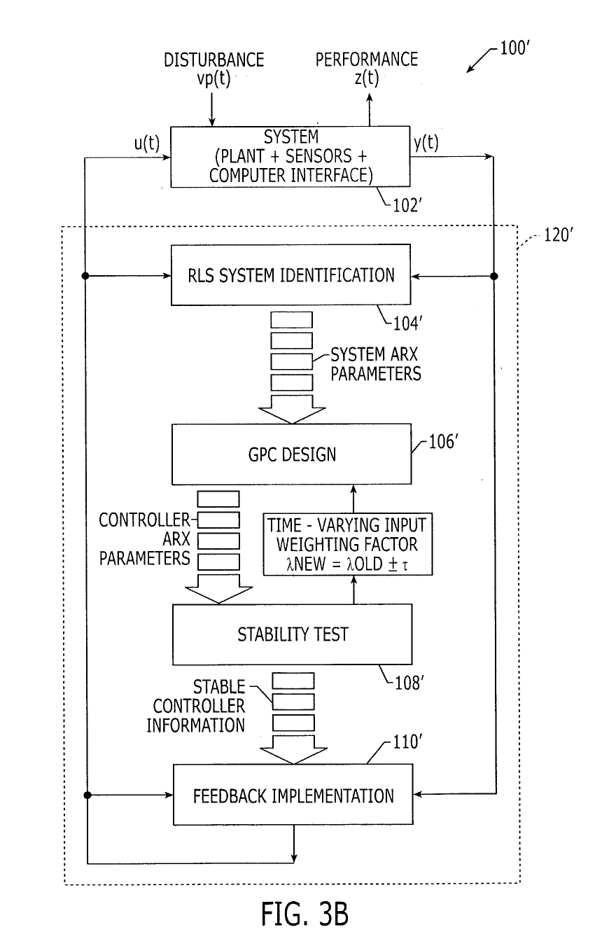

Referring now to FIG. 3A, an apparatus 100 for adaptively controlling a system 102 according to a first embodiment of the present invention includes a system controller 120 that performs recursive least squares (RLS) system identification operations, Block 104, in combination with generalized predictive control design operations, Block 106, to yield a system controller 120 having recursive generalized predictive control (RGPC) characteristics that can simultaneously achieve robust performance and robust stability characteristics. The RGPC operations performed by the system controller 120 can be applied in real-time without prior system (plant) information for control design because the operations for system identification are performed repeatedly. Moreover, the RGPC operations can be applied in the presence of changing operating environments because the control design is updated adaptively.

The system 102 is shown as comprising a plant to be controlled and one or more sensors that detect one or more aspects of the plant operation. In some embodiments of the present invention, the system 102 may be configured to generate a performance variable(s) z(t) in response to a disturbance variable(s) vₚ(t). The system 102 is also responsive to one of more control inputs u(t). In response to the control inputs and the disturbance variable(s) Vₚ(t), the system 102 generates an output(s) y(t), which may be an output of one or more sensors associated with the plant under control.

The (RLS) system identification operations performed at Block 104 include obtaining a system model using control input data u(t) and system output data y(t). This system model may be expressed in ARX form, which expresses the current output as a linear combination of past input and past output data (see, e.g., Equation (1) below, where αᵢ is a system output ARX parameter and βᵢ is a system input ARX parameter). Using system input ARX parameters αᵢ and system output ARX parameters βᵢ, generalized predictive control (GPC) design, Block 106, is performed to minimize a cost function (see, e.g., Equation (21) below, that is a function of a prediction horizon hₚ, a control horizon h_{c} and the time-varying input weighting factor λ(t). In Block 108, operations are performed to test the stability of the system 102 using the system and controller ARX parameters generated during the GPC design operations, Block 106. Next, in Block 110, feedback implementation operations are performed to compute new system inputs u(t) in response to prior input and output data (i.e., prior u(t) and y(t)). These operations are more fully described in an article by coinventors Suk-Min Moon and Robert L. Clark, entitled “Recursive Methods for Optical Jitter Suppression Using Acoustic Actuators,” Proc. SPIE, Smart Structures and Materials 2002, Vol. 4697, pp. 193-204, March 17-21 (2002), the disclosure of which is hereby incorporated herein by reference.

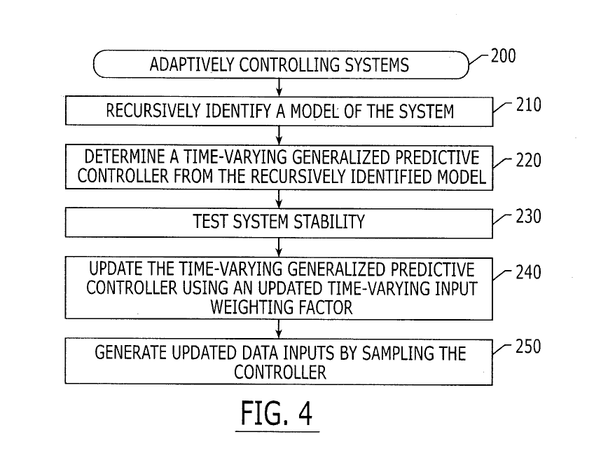

Operations performed by the system controller 120 of FIG. 3A will now be more fully described with respect to FIG. 4. In particular, FIG. 4 illustrates preferred RGPC operations 200 that may be performed in accordance with some embodiments of the present invention. These operations include recursively identifying a model of the system, Blocks 104 and 210. These recursively identifying operations are preferably performed at a first rate from data that is input to the system and sampled at the first rate (or possibly higher rate) and data that is output from the system and sampled at the first (or higher) rate. These methods also include determining a time-varying generalized predictive controller (GPC) that is updated at a second rate less than the first rate, from the recursively identified model, Blocks 106 and 220. This second rate may be less that about one-half or even less than about one-third the first rate. Updated data inputs to the system are also generated on a continuous basis by sampling the time-varying generalized predictive controller at the first rate, Block 250. According to aspects of these embodiments, the operations to determine a time-varying generalized predictive controller, Block 106, include using a first time-varying input weighting factor (λ₁(t)) and then testing a stability of the system to identify it as stable or unstable, Blocks 108 and 230. If desireable to achieve or improve stability, the time-varying generalized predictive controller is updated using a second time-varying input weighting factor that is greater than (or less than) the first time-varying input weighting factor (i.e., (λ_{new}(t)=λ_{old}(t)±τ), Block 240. These operations, which use time-varying input weighting factors and dual sampling rates are preferably performed so that aggressive higher order controllers can be achieved.

The operations to recursively identify a model of the system, Block 104 and 210, may also include evaluating linear combinations of prior input data u(t) to the system and measured prior outputs y(t) from the system to yield system input parameters and system output parameters, which may be ARX parameters. These system ARX parameters may be sampled at the second rate during the operations to determine the time-varying generalized predictive controller. Furthermore, the operations to determine a time-varying generalized predictive controller may also include evaluating a cost function J(t) that is a function of a prediction horizon hₚ, a control horizon h_{c} and the time-varying input weighting factor A(t).

Referring now to FIG. 3B, a apparatus 100′ for adaptively controlling a system 102′ according to another embodiment of the present invention includes a computer-based system controller 120′. This computer-based system controller 120′ includes computer program products that are configured to perform adaptive control operations for a system 102′ comprising plant, sensor and computer interface devices that may be configured to receive the control input data u(t) and generate the system output data y(t). These computer program products include a computer-readable storage medium having computer-readable code embodied in the medium. The computer-readable code includes code 104′ that recursively identifies a model of a system at a first rate from data that is input to the system and sampled at the first rate and data that is output from the system and sampled at the first (or higher) rate. Additional code 106′ is also provided that determines a time-varying generalized predictive controller, which is updated at a second rate that is less than the first rate, from the model identified by the code 104′. This determination of the time-varying generalized predictive controller may also include using a first time-varying input weighting factor (λ(t)). Still further code 110′ is provided that generates an updated data input to the system by sampling the time-varying generalized predictive controller at the higher first rate.

Here, the recursive system identification operations 104, 104′ and 210 in FIGS. 3A-3B and 4 can be performed at a rate which is equivalent to data sampling/acquisition rate because it may update system ARX parameters using matrix summation and multiplication operations instead of more time consuming matrix inversion operations. Moreover, by reducing the rate of change of the system ARX parameters, a slower sampling rate than the data acquisition rate can be used for the generalized predictive controller design, Blocks 106, 106′ and 220. This slower sampling rate may be necessary because the more computationally expensive matrix inversion operations typically must be performed twice during the control design.

Additional computer program products may also include computer-readable program code 104′ that recursively identifies a model of the system by evaluating linear combinations of control inputs to a system 102′ and measured sensor outputs from the system 102′ that are sampled at a first rate. From this recursively identified model, the code 106′ further determines a time-varying generalized predictive controller that is a function of a first time-varying input weighting factor and is updated at a second rate that is less than one-half the first rate. As illustrated by Block 110′, the code may also generate updated control inputs u(t) to the system 102′ by sampling the time-varying generalized predictive controller at the first rate. These control inputs u(t) may be provided to a computer interface unit within the system 102′ that translates these control inputs and signals into those usable by the system plant.

The apparatus 100′ of FIG. 3B further illustrates an exemplary recursive generalized predictive control (RGPC) system, which contains means for recursively identifying a model of a system at a first rate from data that is input to the system and sampled at the first (or higher) rate and data that is output from the system and sampled at the first (or higher) rate, Block 104′. This control system also includes means for determining a time-varying generalized predictive controller that is updated at a second rate less than the first rate and means for generating an updated data input to the system by sampling the time-varying generalized predictive controller at the first rate, Blocks 106′ and 110′. To enhance stability characteristics, the determining means includes means for determining a time-varying generalized predictive controller using a first time-varying input weighting factor (λ_{old}(t)) and means for testing a stability of the system to identify it as stable or unstable, Block 108′. In response to this stability testing, the means for updating the time-varying generalized predictive controller may include improving stability by using a second time-varying input weighting factor (λ_{new}(t)) that has been adjusted by a value |τ|.

In the foregoing sections, a thorough and complete description of preferred embodiments of the present invention have been provided which would enable one of ordinary skill in the art to make and use the same. Nonetheless, a detailed mathematical treatment of the above-described operations will now be provided.

The operations for performing recursive system identification include using linear combinations of past output and input measurements from the system as states, a system can be identified in ARX representation as:

y(t)=−α₁y(t−1)− . . . −αₚy(t−p)+ (1)

where y(t) is the measured output from the system and u(t) is the input to the system. For a system having m outputs and n inputs, the output, y(t), is an m by 1 vector and the input, u(t), is an n by 1 vector. Each coefficient αᵢ(i=1, 2, . . . , p) is an m by m matrix and each coefficient βᵢ (i=1, 2, . . . , p) is an m by n matrix.

The system identification process involves identifying the coefficients, αᵢ and βᵢ, to minimize the prediction error, e(t). The prediction error, e(t), can be written as:

e(t)=y(t)−ŷ(t|t−1) (2)

where the one-step-ahead prediction, ŷ(t|t−1), is the conditional expectation of y(t) which is given as:

ŷ(t|t−1)=θ(t−1)Φ^{T}(t) (3 )

where θ(t−1) is a system parameter matrix,

θ(t−1)=[α₁ . . . αₚβ₁ . . . ], (4)

and Φ(t) is a data vector,

Φ(t)=[−y^{T}(t−1) . . . −y^{T}(t−p)u^{T}(t−1) . . . u^{T}(t−p)]. (5)

A system parameter matrix, θ(t−1), is an m by (m+n)p matrix, and a data vector, Φ^{T}(t) is an (m+n)p by 1 vector.

The recursive least squares (RLS) method can be summarized as:

θ(t)=θ(t−1)+{y(t)−θ(t−1)Φ^{T}(t)}L(t) (6)

where θ(t) is the new estimation of system parameters, θ(t−1) is the old estimation of system parameters, y(t) is the new output measurement, θ(t−1)Φ^{T}(t) is the one-step-ahead prediction of the new measurement, and L(t) is the correcting factor given as:

$$L ( t ) = \frac{ϕ ( t ) P ( t - 1 )}{1 + ϕ ( t ) P ( t - 1 ) {ϕ}^{T} ( t )} \qquad ( 7 )$$

It is noted that the denominator of L(t), 1+Φ(t)P(t−1)Φ^{T}(t) becomes a scalar. Thus, the updating algorithm for correcting factors, L(t), has scalar division rather than matrix inversion.

The initial conditions for the recursive system identification algorithm can be set as:

\hat{θ}(0)=zeros(m,(m+n)p)

P(0)=αeye((m+n)p) (8)

where zeros(m,(m+n)p) is a m by (m+n)p zero matrix, and eye((m+n)p) is a (m+n)p identify matrix, where m is the number of system outputs and n is the number of system inputs. The gain, α, is a positive number. For the time invariant system, a small value of the gain will allow the system parameters to be updated gradually, without significant changes. In some embodiments, the gain, α, is set to be 10¹ in the recursive system identification process.

The operations for determining a time-varying generalized predictive controller will now be described. The generalized predictive controller is designed for a system written in ARX form such as:

α₀y(t)+α₁y(t−1)+ . . . +αₚy(t−p)=β₀u(t)+β₁u(t−1)+ . . . +βₚu(t−p) (9)

where αᵢ (i=0, . . . , p) and βᵢ (i=0, . . . , p) are ARX parameters. Each output ARX parameter, α₀=eye(m) and αᵢ, is an m by m matrix where eye(m) is an m by m identity matrix. Each input ARX parameter, β₀=zeros(m,n) and βᵢ, is an m by n matrix where zeros(m,n) is an m by n matrix with zero entries. For systems having m outputs and n inputs, the output, y(t), is an m by 1 vector and the input, u(t), is an n by 1 vector. For a single-input and single-output system, α₀=1 and β₀=0.

The ARX system equation, given in Equation (9), can be written in matrix form as:

Ayₚ=Buₚ, (10)

where output ARX parameter matrix, A, is an m by m(p+1) matrix, and input ARX parameter matrix, B, is an m by n(p+1) matrix. These parameter matrices can be written as:

$$\begin{matrix}A = [ eye ( m ) {α}_{1} … {α}_{p} ] \\ B = [ zeros ( m , n ) {β}_{1} … {β}_{p} ] .\end{matrix} \qquad ( 11 )$$

The output vector, yₚ, and the input vector, uₚ, in Equation (10), are:

$${y}_{p} = [ \begin{matrix}y ( t ) \\ y ( t - 1 ) \\ ⋮ \\ y ( t - p )\end{matrix} ] {u}_{p} = [ \begin{matrix}u ( t ) \\ u ( t - 1 ) \\ ⋮ \\ u ( t - p )\end{matrix} ] \qquad ( 12 )$$

Constructing the q step predictor at time k and partitioning it into past and future parts, the following matrix equation is obtained:

$$[ F \vert G ] [ \frac{{y}_{P} ( k )}{{y}_{F} ( k )} ] = [ H \vert J ] [ \frac{{u}_{P} ( k )}{{u}_{F} ( k )} ] , \qquad ( 13 )$$

where matrices F and G are written as:

$$[ F \vert G ] = [ \begin{matrix}{α}_{p} & ⋯ & {α}_{1} & {α}_{0} & 0 & 0 & ⋯ & 0 & 0 \\ 0 & ⋰ & ⋰ & ⋰ & ⋰ & ⋰ & ⋮ & ⋮ & ⋮ \\ ⋮ & 0 & {α}_{p} & ⋮ & {α}_{1} & {α}_{0} & 0 & ⋯ & 0 \\ ⋮ & ⋮ & 0 & {α}_{p} & ⋮ & {α}_{1} & {α}_{0} & 0 & 0 \\ ⋮ & ⋮ & ⋮ & ⋰ & ⋰ & ⋰ & ⋰ & ⋮ & ⋮ \\ 0 & ⋯ & 0 & 0 & 0 & {α}_{p} & ⋯ & {α}_{1} & {α}_{0}\end{matrix} ] \qquad ( 14 )$$

and matrices H and J are written as:

$$[ H \vert J ] = [ \begin{matrix}{β}_{p} & ⋯ & {β}_{1} & {β}_{0} & 0 & 0 & ⋯ & 0 & 0 \\ 0 & ⋰ & ⋰ & ⋰ & ⋰ & ⋰ & ⋮ & ⋮ & ⋮ \\ ⋮ & 0 & {β}_{p} & ⋮ & {β}_{1} & {β}_{0} & 0 & ⋯ & 0 \\ ⋮ & ⋮ & 0 & {β}_{p} & ⋮ & {β}_{1} & {β}_{0} & 0 & 0 \\ ⋮ & ⋮ & ⋮ & ⋰ & ⋰ & ⋰ & ⋰ & ⋮ & ⋮ \\ 0 & ⋯ & 0 & 0 & 0 & {β}_{p} & ⋯ & {β}_{1} & {β}_{0}\end{matrix} ] \qquad ( 15 )$$

It is noted that the coefficient matrix of the past output, F, is an m(p+q) by mp block upper triangular matrix, the coefficient matrix of the future output, G, is an m(p+q) by m(p+q) block lower triangular matrix, the coefficient matrix of the past input, H, is an m(p+q) by np block upper triangular matrix, and the coefficient matrix of the future input, J, is an m(p+q) by n(p+q) block lower triangular matrix. The matrix G is a square matrix. It is also noted that system parameters in Equations (14) and (15) are reordered from Equation (11).

The mp by 1 output past history vector, y_{P}(k), and the m(p+q) by 1 future output vector, y_{F}(k), can be written as:

$${y}_{P} ( k ) = [ \begin{matrix}y ( k - p ) \\ ⋮ \\ y ( k - 1 )\end{matrix} ] {y}_{F} ( k ) = [ \begin{matrix}y ( k ) \\ ⋮ \\ y ( k + p + q - 1 )\end{matrix} ] . \qquad ( 16 )$$

The np by 1 input past history vector, u_{P}(k), and the n(p+q) by 1 future input vector, u_{F}(k), can be written as:

$${u}_{P} ( k ) = \begin{matrix}u ( k - p ) \\ ⋮ \\ u ( k - 1 )\end{matrix} {u}_{F} ( k ) = [ \begin{matrix}u ( k ) \\ ⋮ \\ u ( k + p + q - 1 )\end{matrix} ] . \qquad ( 17 )$$

Equation (13) can be solved for future outputs and the coefficients can be normalized by multiplying the inverse of the coefficient matrix of the future output,

y_{F}(k)=G⁻¹Ju_{F}(k)+G⁻¹Hu_{P}(k)−G⁻¹Fy_{P}(k) (18)

Writing the normalized coefficient matrices as:

T_{c}=G⁻¹J, B_{c}=G₋₁H, A_{c}=−G⁻¹F (19)

equation (18) can be rewritten as:

y_{F}(k)=T_{c}u_{F}(k)+B_{c}u_{P}(k)+a_{c}y_{P}(k). (20)

Defining the prediction horizon to be hₚ=p+q−1, the normalized coefficient matrix of the future input, T_{c}, is an m(hₚ+1) by n(hₚ+1) matrix. The normalized coefficient matrix of the past input, B_{c}, is an m(hₚ+1) by np matrix, and the normalized coefficient matrix of the past output, A_{c}, is an m(hₚ+1) by mp matrix.

The cost function to be minimized in the generalized predictive control is defined as:

$$\begin{matrix}J ( k ) = {y}^{\frac{T}{F}} ( k ) {y}_{F} ( k ) + {u}^{\frac{T}{F}} ( k ) λ {u}_{F} ( k ) \\ = {\sum }_{j = 0}^{{h}_{p}} \{ {y ( k + j )}^{T} y ( k + j ) \} + {\sum }_{j = 0}^{{h}_{c}} \{ {u ( k + j )}^{T} λ u ( k + j ) \}\end{matrix} \qquad ( 21 )$$

where λ is the input weighting factor or control penalty, hₚ is the prediction horizon, and h_{c} is the control horizon, which is less than the prediction horizon, i.e., h_{c}≦hₚ.

The future input, UF, that satisfies the equation, dJ(k)/du_{F}=0, is:

u_{F}(k)=−[T_{c}^{C}T_{c}+λI]⁻¹T_{c}(B_{c}u_{P}(k)+A_{c}y_{P}(k)). (22)

The control input at time k is defined by the first n rows of the future input, i.e., u(k)= the first n rows of

{−[T_{c}^{T}T_{c}+λI]⁻¹T_{c}}(B_{c}u_{P}(k)+A_{c}y_{P}(k)). (23)

The input weighting factor or the control penalty, λ, is assumed to be a positive scalar. The closed-loop system will be unstable when λ=0 because T_{c} will be rank deficient (T_{c}=G⁻¹J and J is rank deficient by β₀=0).

The control input given in Equation (23) is when the control horizon is equal to the prediction horizon. When the control horizon is less than the prediction horizon, the solution that minimizes the cost function, J(k), given in Equation (21), can be achieved by reducing the size of the coefficient matrix J in Equation (15) to be J(1:m(hₚ+1), 1:n(h_{c}+1)). The shorter control horizon means the control input is assumed to be zero for all values beyond the control horizon.

Operations for testing the stability of the controller will now be described. Because it can be shown that in the absence of pole-zero cancellations in the transfer function, the system eigenvalues and transfer function poles are identical, the stability of the controller can also be checked in the following manner. From Equation (23), the controller can be written in the discrete transfer form,

y_{c}(k)=β₁^{c}y_{c}(k−1)+β₂^{c}y_{c}(k−2)+ . . . +βₚ^{c}y_{c}(k−p) +α₁^{c}u_{c}(k−1)+α₂^{c}u_{c}(k−2)+ . . . αₚ^{c}u_{c}(k−p) (24)

where the input to the controller, u_{c}(k), is the output of the system, y(k), and the output of the controller, y_{c}(k), is the input to the system, u(k). The coefficients of u_{c}(k−i), αᵢ^{c}(i=1, . . . , p), and the coefficients of y_{c}(k−i), βᵢ^{c}(i=1, . . . , p), use superscript c to distinguish them from the coefficients used for the system ARX parameters, αᵢ and βᵢ. Each αᵢ^{c} has the size of n by m and each βᵢ^{c} has the size of n by n, where m is the number of system outputs and n is the number of system inputs.

Writing the controller in the discrete transfer function form,

$$\frac{{y}_{c} ( k )}{{u}_{c} ( k )} = \frac{{α}^{\frac{c}{1}} {z}^{- 1} + {α}^{\frac{c}{2}} {z}^{- 2} + … + {α}^{\frac{c}{p}} {z}^{- p}}{1 - {β}^{\frac{c}{1}} {z}^{- 1} - {β}^{\frac{c}{2}} {z}^{- 2} - … - {β}^{\frac{c}{p}} {z}^{- p}} \qquad ( 25 )$$

the stability condition of the controller is as follows,

max(abs(roots([1−β₁^{c}−β₂^{c} . . . −βₚ^{c}])))<1(26)

where the operator “max” is the maximum value of the given vector, the operator “abs” means the magnitude of the given vector elements, and the operator “roots” is the roots of the given polynomial coefficient vector.

For a multiple input system, each βᵢ^{c} (i=1, . . . , p) is an n by n matrix, where n is the number of system inputs. In such a case, stability is checked for each element of the matrices βᵢ^{c}. When all the polynomials satisfy the stability condition, the multi-input, multi-output controller is stable.

According to other aspects of these operations, two new parameters can be defined to express the effect of a greater prediction horizon and a shorter control horizon. To express the effect of a greater prediction horizon, the generalized predictive controller is derived in the following manner. For a given set of the identified system parameters each coefficient matrix in Equation (14) and (15) is partitioned by the last row and the last column:

$$F = [ \begin{matrix}{F}_{1} \\ {F}_{2}\end{matrix} ] , G = [ \begin{matrix}{G}_{1} & 0 \\ {A}_{hp} & {α}_{0}\end{matrix} ] , H = [ \begin{matrix}{H}_{1} \\ {H}_{2}\end{matrix} ] , J = [ \begin{matrix}{J}_{1} & 0 \\ {B}_{h p} & {β}_{0}\end{matrix} ] , \qquad ( 27 )$$

where the coefficient matrices, F, G, H, and J, are for the prediction horizon, hₚ, and the control horizon, h=hₚ. The coefficient matrices with subscript 1, F₁, G₁, H₁, and J₁, correspond to a one-step shorter prediction horizon and control horizon, hₚ−1. The matrix G₁ is the coefficient matrix of the future output when the prediction horizon is hₚ−1. Hence, the size of the square matrix G₁ is m(hₚ−1) by m(hₚ−1). The matrix J₁ is the coefficient matrix of the future input when the prediction horizon is hₚ−1, and its size is n(hₚ−1) by m(hₚ−1). Vectors Aₕₚ and F₂ are generated from identified system output parameters, α₁, and vectors Bₕₚ and H₂ are generated from identified system input parameters, βᵢ. For a larger prediction horizon than the identified system order, the extra row in matrices F and H, and F₂ and H₂, are zero vectors.

Designing the generalized predictive controller using the coefficient matrices in Equation (27) with α=1 and β₀=0, the following parameter can be derived to describe the effect of an extra prediction horizon,

$$L = \frac{1}{trace ( {( - {A}_{h p} {T}_{c1} + {B}_{h p} )}^{T} ( - {A}_{h p} {T}_{c1} + {B}_{h p} ) )} \qquad ( 28 )$$

where T_{c1}=G₁⁻¹J₁.

In addition, the parameter L can be normalized by the parameter value L when the prediction horizon is set to be the identified system order, p. Writing the parameter value L when the prediction horizon is set to be the identified system order, p, as Lₚ, the normalized parameter value, Lₕₚ, can be written as:

$$\begin{matrix}{L}_{h p} = \frac{L}{{L}_{p}} \\ = \frac{trace ( {( - {A}_{h p} {T}_{c1} + {B}_{h p} )}^{T} ( - {A}_{h p} {T}_{c1} + {B}_{h p} ) ) {\vert}_{h p = p}}{trace ( {( - {A}_{h p} {T}_{c1} + {B}_{h p} )}^{T} ( - {A}_{h p} {T}_{c1} + {B}_{h p} ) )}\end{matrix} \qquad ( 29 )$$

The parameter Loop has the following properties:

1. Lₕₚ is a positive number;

2. When Lₕₚ≧1, the prediction horizon is smaller than the identified system order. When Lₕₚ≧1, the prediction horizon is larger than the identified system order. The parameter, Lₕₚ, is equal to 1 when the prediction horizon is set to be the identified system order, p;

3. For infinite prediction horizon and control horizon, Lₕₚ goes to zero;

4. A smaller value of Lₕₚ corresponds to a larger prediction horizon; and

5. The parameter, Lₚ, is independent of the input weighting factor, λ.

Longer calculation time may be required to design a controller with a smaller value of prediction horizon parameters, Lₕₚ, because as the prediction horizon increases, the size of the coefficient matrices also increase because their sizes are proportional to the size of Lₕₚ.

Assuming the prediction horizon, ĥₚ, is obtained from the chosen value of Lₕₚ, a shorter control horizon than prediction horizon can be defined. The effect of the shorter control horizon can be expressed by partitioning matrix J in Equation (15) as follows:

J=[J₃ J₄] (30)

where J is the coefficient matrix when control horizon is h_{c}=ĥₚ. A matrix with subscript 3 corresponds the coefficient matrices when the control horizon is ĥₚ−1. As mentioned before, a shorter control horizon affects only to the coefficient matrix J. Hence, coefficient matrices F, G, and H remain the same for shorter control horizon. As the control horizon decreases, the column of matrix J₃ decreases but the row of matrix J₃ remains the same.

The normalized coefficient matrix of the future output, T_{c}, is obtained as:

T_{c}=G⁻¹J=[T_{c3} Tc_{c4}] (31)

where T_{c3}=G⁻¹J₃, which is the normalized coefficient matrices for the future input when the control horizon is ĥₚ−1 and T_{c4}=G⁻¹J₄.

From the properties of the normalized coefficient matrices, T_{c3}+λI₃ is invertable. The matrix T_{c4}+λI₄ is also invertable except when h_{c}=ĥₚ (because β₀=0). With the fact that the shorter control horizon improves system response, the following parameter can be defined to represent the effect of the shorter control horizon:

$$\begin{matrix}{L}_{hc } = \frac{1}{trace ( {S}^{T} S )} & ( 32 ) \\ where & \\ S = {{T}_{c4} ( {T}_{\frac{T}{c4}} {T}_{c4} + ϵ {I}_{4} )}^{- 1} {T}_{\frac{T}{c4}} & ( 33 )\end{matrix}$$

Note that λ is replaced by ∈, which is a very small positive number. With a very small positive number, ∈, the control horizon parameter, L_{hc}, becomes 1 when h_{c}=ĥₚ−1. When h_{c}=ĥₚ, the matrix, T,_{c4}, becomes a zero matrix because β₀=0, and the parameter, L_{hc}, becomes infinity.

Hence, the control horizon parameter, L_{hc}, has the following properties:

1. L_{hc} is a positive number;

2. When control horizon is equal to prediction horizon, h_{c}=ĥₚ the parameter, L_{hc}, becomes infinity. When control horizon is less than prediction horizon, L_{hc}≦1 (L_{hc}=1 when h_{c}=ĥ_{c-1}); and

3. A smaller value of L_{hc} corresponds to a shorter control horizon.

To illustrate the prediction horizon parameter, Lₕₚ, and the control horizon parameter, L_{hc}, the following ARX model with sampling rate of 250 Hz is used.

A(1)y(t)+ . . . +A(p+1)y(t−p)=B(1)u(t)+ . . . +B(p+1)u(t−p) (34)

where the output coefficient vector, A, and the input coefficient vector, B, are identified system parameters, obtained as:

A=[1, −0.0443, −0.0232, −0.0856, 0.1898, −0.0223, −0.1500, −0.0157, −0.2728, −0.1018, 0.1246, −0.0611, 0.1652, 0.0380, −0.2291, −0.0467, −0.1759]

B=[0, −0.0052, −0.0157, 0.0263, −0.0076, 0.0070, 0.0210, −0.0390, 0.0032, 0.0021, −0.0154, 0.0266, −0.0004, −0.0035, 0.0067, −0.0135, 0.0015]

Calculating the prediction horizon parameter, LhP,=50%, and the control horizon parameter, L_{hc}=20%, the prediction horizon is obtained as ĥₚ=32 and the control horizon is obtained as h_{c}=26. As the prediction horizon increases, the system response improves. But, there is a tradeoff because a larger prediction horizon requires longer computational time in the controller design. Moreover, because the shorter control horizon improves the system response, the generalized predictive controller will be more aggressive as the prediction horizon becomes longer and the control horizon becomes shorter.

According to further aspects of these operations, a recursive generalized predictive controller can be obtained by designing the generalized predictive controller using the updated system parameters obtained by the recursive system identification operations. In the process of the recursive system identification, the system order must be chosen. The identified system order will be of the order of the generalized predictive controller. In the process of the generalized predictive controller design, the following control parameters should be chosen properly: the prediction horizon, the control horizon, and the input weighting factor. The prediction horizon and the control horizon are the finite horizons of the system output and control input predictions. Choosing a prediction horizon and a control horizon, the smaller values of prediction horizon parameter and control horizon parameter will improve the system performance, but the following effects should be considered. First, the smaller value for prediction horizon parameter, Lₕₚ, requires longer sampling time for the control design process. Second, the smaller value for control horizon parameter, L_{hc}, requires a larger magnitude of the control input.

To design higher order controllers and aggressive controllers, dual-sampling-rate operations and a time varying input weighting factor can be used. Stability test operations can also be used to avoid implementation of unstable controllers. In particular, when the recursive generalized predictive controller is applied to a real experimental setup, dual-sampling-rate operations can be applied to design a higher-order controller. First, the recursive system identification can be applied to the real experimental setup with the same sampling rate as the data acquisition since it updates the system parameters using matrix summations and multiplications without any time consuming process such as matrix inversion. Second, assuming that the system parameters do not change significantly, which can be controlled by the initial conditions of the recursive system identification method, a slower sampling rate than the data acquisition sampling rate can be used for controller design, because matrix inversion must be performed twice during the control design, (see Equations (19) and (23)). The controller is fixed until a new controller is computed and updated. Third, the control input can be calculated with the measured and stored input and output data using the same sampling rate as that used for the data acquisition.

A time varying input weighting factor algorithm is also applied to improve stability characteristics. As explained in the foregoing description, a zero value of the input weighting factor will result in an unstable controller. When a small positive constant value of the input weighting factor is chosen in the controller design, the controller also can create an instability since the matrix, T_{c} in Equation (19), is close to singular. Second, even if the controller is stable, when applied to a real experimental setup, it may result in a large magnitude of initial control input, which may cause an overload in the experimental hardware. Third, a large constant value of the input weighting factor may reduce the magnitude of the initial control input, but limits performance. To avoid those potential problems, a time varying input weighting factor is added to the controller design,

λ_{new}=λ_{old}±τ (35)

where λ_{new} is the updated input weighting factor from the previous input weighting factor, λ_{old}. The value of τ is added or subtracted, depending on the stability of the controller. The negative sign is applied for stable controllers and the positive sign is applied for unstable controllers.

By assigning a large initial value of the input weighting factor, a large magnitude of the initial control input can be avoided. Once the controller is designed and applied to the system, the input weighting factor will be updated based on the stability of the controller. The value will be reduced for a stable controller and increased for an unstable controller until a stable controller is obtained. The value of τ in Equation (35) can be scaled with respect to the input weighting factor. For example, when the input weighting factor is 0.01, the proper size of τ is 0.001, an order of magnitude less. To apply the time varying input weighting factor to the system, the following process should be added in the controller design. When the value of λ approaches a very small number, λₘᵢₙ, the decrement should be zero because the input weighting factor is a positive real number. By adding this process, a zero or negative value of the input weighting factor can be avoided. Second, since the weighting factor is updated after the stability test, application of unstable controllers can be avoided. If an unstable controller results upon checking for stability, the previous stable controller is implemented instead. By adding these operations to the controller design, only stable controllers are applied to the system.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of adaptively controlling a system, comprising the steps of:
recursively identifying a model of the system at a first rate from data that is input to the system and sampled at the first or higher rate and data that is output from the system and sampled at the first or higher rate;
determining a time-varying generalized predictive controller that is updated at a second rate less than the first rate, from the recursively identified model; and
generating an updated data input to the system by sampling the time-varying generalized predictive controller at the first or higher rate.

2. The method of claim 1, wherein said determining step comprises determining a time-varying generalized predictive controller using a first time-varying input weighting factor.

3. The method of claim 2, further comprising the steps of:
testing a stability of the system to identify it as stable or unstable; and
updating the time-varying generalized predictive controller using a second time-varying input weighting factor that is greater than or less than the first time-varying input weighting factor.

4. The method of claim 1, wherein said recursively identifying step comprises evaluating linear combinations of prior data to the system and measured prior outputs from the system to yield system input parameters and system output parameters.

5. The method of claim 4, wherein said step of determining a time-varying generalized predictive controller comprises sampling the system input parameters and the system output parameters at the second rate.

6. The method of claim 5, wherein said step of determining a time-varying generalized predictive controller comprises evaluating a cost function that is a function of a prediction horizon, a control horizon and a time-varying input weighting factor.

7. The method of claim 1, wherein said step of determining a time-varying generalized predictive controller comprises evaluating a cost function that is a function of a prediction horizon, a control horizon and a time-varying input weighting factor.

8. The method of claim 4, wherein the system input parameters and the system output parameters are ARX parameters.

9. A method of adaptively controlling a system, comprising the steps of:
recursively identifying a model of the system by evaluating linear combinations of control inputs to the system and measured sensor outputs from the system that are sampled at a first rate;
determining a time-varying generalized predictive controller that is a function of a first time-varying input weighting factor and is updated at a second rate that is less than one-half the first rate, from the recursively identified model; and
generating an updated control input to the system by sampling the time-varying generalized predictive controller at the first rate.

10. The method of claim 9, further comprising the steps of:
testing a stability of the system to identify it as stable or unstable; and
updating the time-varying generalized predictive controller using a second time-varying input weighting factor that is greater than or less than the first time-varying input weighting factor.

11. The method of claim 9, wherein said recursively identifying step comprises generating ARX system input parameters and ARX system output parameters.

12. The method of claim 11, wherein said step of determining a time-varying generalized predictive controller comprises sampling the ARX system input parameters and the ARX system output parameters at the second rate.

13. The method of claim 12, wherein said step of determining a time-varying generalized predictive controller comprises evaluating a cost function that is a function of a prediction horizon, a control horizon and the first time-varying input weighting factor.

14. A method of adaptively controlling a system, comprising the steps of:
recursively identifying a model of the system from data that is input to the system and data that is output from the system;
determining a time-varying generalized predictive controller from the recursively identified model, using a first time-varying input weighting factor;
testing a stability of the system to identify it as stable or unstable;
updating the time-varying generalized predictive controller using a second time-varying input weighting factor that is greater than or less than the first time-varying input weighting factor; and
generating an updated data input to the system by sampling the updated time-varying generalized predictive controller.

15. The method of claim 14, wherein said recursively identifying step comprises recursively identifying a model of the system at a first rate from data that is input to the system and sampled at the first or higher rate and data that is output from the system and sampled at the first or higher rate; and wherein said determining step comprises determining a time-varying generalized predictive controller that is updated at a second rate less than the first rate.

16. The method of claim 14, wherein said recursively identifying step comprises evaluating linear combinations of prior inputs to the system and measured prior outputs from the system to yield system input parameters and system output parameters that are updated without using matrix inversion operations.

17. A computer program product that is configured to perform adaptive control operations, said computer program product comprising a computer-readable storage medium having computer-readable code embodied in the medium, said computer-readable program code comprising:
computer-readable code that recursively identifies a model of a system at a first rate from data that is input to the system and sampled at the first or higher rate and data that is output from the system and sampled at the first or higher rate;
computer-readable code that determines a time-varying generalized predictive controller that is updated at a second rate less than the first rate, from the recursively identified model; and
computer-readable code that generates an updated data input to the system by sampling the time-varying generalized predictive controller at the first or higher rate.

18. The computer program product of claim 17, wherein said computer-readable code comprise computer-readable code that determines a time-varying generalized predictive controller using a first time-varying input weighting factor.

19. A computer program product that is configured to perform adaptive control operations, said computer program product comprising a computer-readable storage medium having computer-readable code embodied in the medium, said computer-readable program code comprising:
computer-readable code that recursively identifies a model of the system by evaluating linear combinations of control inputs to a system and measured sensor outputs from the system that are sampled at a first rate;
computer-readable code that determines a time-varying generalized predictive controller that is a function of a first time-varying input weighting factor and is updated at a second rate that is less than one-half the first rate, from the recursively identified model; and
computer-readable code that generates an updated control input to the system by sampling the time-varying generalized predictive controller at the first rate.

20. A recursive generalized predictive controller, comprising:
means for recursively identifying a model of a system at a first rate from data that is input to the system and sampled at the first or higher rate and data that is output from the system and sampled at the first or higher rate;
means, responsive to said recursively identifying means, for determining a time-varying generalized predictive controller that is updated at a second rate less than the first rate; and
means, responsive to said determining means, for generating an updated data input to the system by sampling the time-varying generalized predictive controller at the first or higher rate.

21. The controller of claim 20, wherein said determining means comprises means for determining a time-varying generalized predictive controller using a first time-varying input weighting factor.

22. The controller of claim 21, further comprising:
means, responsive to said determining means, for testing a stability of the system to identify it as stable or unstable; and
means, responsive to said testing means, for updating the time-varying generalized predictive controller using a second time-varying input weighting factor that is greater than or less than the first time-varying input weighting factor.

23. The controller of claim 20, wherein said recursively identifying means comprises means for evaluating linear combinations of prior data to the system and measured prior outputs from the system to yield system input parameters and system output parameters.

24. The controller of claim 23, wherein said determining means comprises means for sampling the system input parameters and the system output parameters at the second rate.

25. The controller of claim 24, wherein said determining means comprises means for evaluating a cost function that is a function of a prediction horizon, a control horizon and a time-varying input weighting factor.

26. The controller of claim 20, wherein said determining means comprises means for evaluating a cost function that is a function of a prediction horizon, a control horizon and a time-varying input weighting factor.

27. A predictive controller, comprising:
means for recursively identifying a model of a system by evaluating linear combinations of control inputs to the system and measured sensor outputs from the system that are sampled at a first rate;
means, responsive to said recursively identifying means, for determining a time-varying generalized predictive controller that is a function of a first time-varying input weighting factor and is updated at a second rate that is less than one-half the first rate, from the recursively identified model; and
means, responsive to said determining means, for generating an updated control input to the system by sampling the time-varying generalized predictive controller at the first rate.

28. A predictive controller, comprising:
means for recursively identifying a model of the system from data that is input to the system and data that is output from the system;
means, responsive to said recursively identifying means, for determining a time-varying generalized predictive controller from the recursively identified model, using a first time varying input weighting factor;
means, responsive to said determining means, for testing a stability of the system to identify it as stable or unstable;
means, responsive to said testing means, for updating the time-varying generalized predictive controller using a second time-varying input weighting factor that is greater than or less than the first time-varying input weighting factor; and
means, responsive to said updating means, for generating an updated data input to the system by sampling the updated time-varying generalized predictive controller.
